(19) United States
(12) Patent Application Publication
(10) Pub. No.: US 2012/0302270 A1
(43) Pub. Date: Nov. 29, 2012

(54) METHOD AND APPARATUS FOR PROVIDING CONTENT PROVIDERS FOR RECOMMENDATION SERVICES

(75) Inventor: Sailesh Kumar Sathish, Tampere (FI)

(73) Assignee: Nokia Corporation, Espoo (FI)

(21) Appl. No.: 13/115,679

(22) Filed: May 25, 2011

(51) Int. Cl. H04W 4/00

(52) U.S. Cl. 455/500

(57) ABSTRACT

An approach is presented for providing data providers for recommendations services. A data provider platform receives at least one request for at least one recommendation from at least one device. The data provider platform further determines context information associated with the at least one device, a user of the at least one device, or a combination thereof. The data provider platform further processes and/or facilitates a processing of the context information to determine, at least in part, one or more providers for generating the at least one recommendation.

### BACKGROUND

Service providers and device manufacturers (e.g., wireless, cellular, etc.) are continually challenged to deliver value and convenience to consumers by, for example, providing compelling network services. One such service is providing recommendations to consumers concerning, for example, where to eat, shop, watch a movie, attend a concert, visit local attractions, etc. Providing such a service requires a vast amount of data to support the multitude of recommendations for the various different categories. Where the service is offered over a large geographical area, the amount of data required to support the service multiplies creating problems regarding both sourcing and economy. Dividing the content providers into smaller regions can lead to duplicity related to the content providing and the problem that content providers may only provide one type of content. There is also no way to let consumers select what content provider to use or recommend content providers for a particular content. As such, service providers face significant technical challenges to providing content providers for recommendation services.

### SOME EXAMPLE EMBODIMENTS

Therefore, there is a need for an approach for providing content providers for recommendation services based on a context-driven, content-sourcing framework.

According to one embodiment, a method comprises receiving at least one request for at least one recommendation from at least one device. The method also comprises determining context information associated with the at least one device, a user of the at least one device, or a combination thereof. The method further comprises processing and/or facilitating a processing of the context information to determine, at least in part, one or more providers for generating the at least one recommendation.

According to another embodiment, an apparatus comprises at least one processor, and at least one memory including computer program code for one or more programs, the at least one memory and the computer program code configured to, with the at least one processor, cause, at least in part, the apparatus to receive at least one request for at least one recommendation from at least one device. The apparatus is also caused to determine context information associated with the at least one device, a user of the at least one device, or a combination thereof. The apparatus is further caused to process and/or facilitate a processing of the context information to determine, at least in part, one or more providers for generating the at least one recommendation.

According to another embodiment, a computer-readable storage medium carries one or more sequences of one or more instructions which, when executed by one or more processors, cause, at least in part, an apparatus to receive at least one request for at least one recommendation from at least one device. The apparatus is also caused to determine context information associated with the at least one device, a user of the at least one device, or a combination thereof. The apparatus is further caused to process and/or facilitating a processing of the context information to determine, at least in part, one or more providers for generating the at least one recommendation.

According to another embodiment, an apparatus comprises means for receiving at least one request for at least one recommendation from at least one device. The apparatus also comprises means for determining context information associated with the at least one device, a user of the at least one device, or a combination thereof. The apparatus further comprises means for processing and/or facilitating a processing of the context information to determine, at least in part, one or more providers for generating the at least one recommendation.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing content providers for recommendation services, according to one embodiment;

FIG. 2 is a diagram of the components of a recommendation platform, according to one embodiment;

FIG. 3 is a flowchart of a process for providing content providers for recommendation services, according to one embodiment;

FIG. 4 is a flowchart of a process for registering and/or updating content providers for recommendation services, according to one embodiment;

FIGS. 5A-5D are diagrams of user interfaces utilized in the processes of FIG. 3, according to various embodiments;

FIG. 6 is a diagram of a user interface utilized in the process of FIG. 4, according to one embodiment;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for providing content providers for recommendation services are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

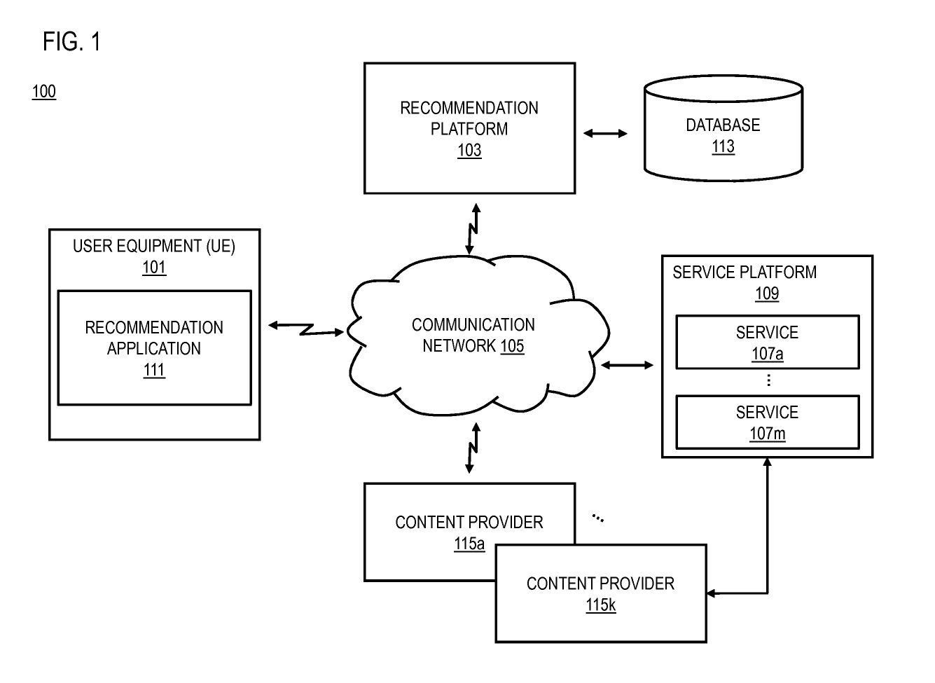

FIG. 1 is a diagram of a system capable of providing content providers for recommendation services, according to one embodiment. As discussed above, recommendation services require content to recommend to a user. When the area over which recommendation services are provided is small (for example, location based recommendations), the problem of providing the content for the recommendation services is simple. When the area over which recommendation services are provided is large, the problem of providing the content for the recommendation services is more complex in terms of economy and sourcing. The large area can be divided into smaller regions, and the regions can be divided into even smaller territories. However, two or more content providers that provide the same content for the same area can result in duplicated content. Additionally, certain content providers may only provide one type of content. The strict division of content providers also does not allow the user to select which one or more of the content providers to use for the recommendation services. Nor does the strict division of content providers allow the service provider that provides the recommendation services to recommend one or more content providers to the user for a particular type of content.

To address this problem, a system 100 of FIG. 1 introduces the capability to provide content providers for recommendation services based, at least in part, on user context information. The system 100 also allows further filtering of the available content providers to narrow the content providers that provide content for the recommendation services to those that provide the specific type of content requested by the user (e.g., restaurant information content). The system 100 also introduces the ability to recommend content providers to the user for providing the content for the recommendation services based on, for example, the user's preferences, past behaviors, etc. Where certain recommendations are linked, such as parking recommendation services being linked to restaurant recommendation services, the system 100 also introduces the ability to present linked content providers for linked recommendation services to the user to receive recommendations that the user did not explicitly request but will still render valuable assistance to the user. The system 100 also introduces a simple way for content providers to register and update the information they provide and the relevance information that links the content to requests from users.

As shown in FIG. 1, the system 100 comprises user equipment (UE) 101 having connectivity to a recommendation platform 103, a service platform 109 and one or more content providers 115a-115k (collectively referred to as content providers 115) via a communication network 105. The UE 101 runs a recommendation application 111 that interacts with the recommendation platform 103 and allows the user to use the services of the recommendation platform 103 from the UE 101. The service platform 109 provides one or more services 107a-107m (collectively referred to as services 107), for example recommendation services, location based services, mapping information services, social networking services, etc.). The system also includes a database 113 that stores information used by the recommendation platform 103, discussed below. The content providers 115 provide content to any one or more of the service platform 109, the recommendation platform 103 and the UE 101 or recommendation application 11 running on the UE 101. The content providers that are provided by the recommendation platform 103 that provide the content for the recommendation services are included among the content providers 115.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, the recommendation platform 103, the service platform 109 and the content providers 115 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

Although FIG. 1 illustrates the recommendation platform 103 as separate component of the system 100, other embodiments are possible. In one embodiment, the recommendation application 111 on the UE 101 is replaced by the recommendation platform 103 running as an application on the UE 101. In this situation, the user operating the UE 101 directly interacts with the recommendation platform 103 as an application. In one embodiment, the recommendation platform 103 is provided as a service 107b by the service platform 109. In the various embodiments, although the recommendation platform 103 can take different forms, the features of the recommendation platform 103 remain the same but merely in different forms.

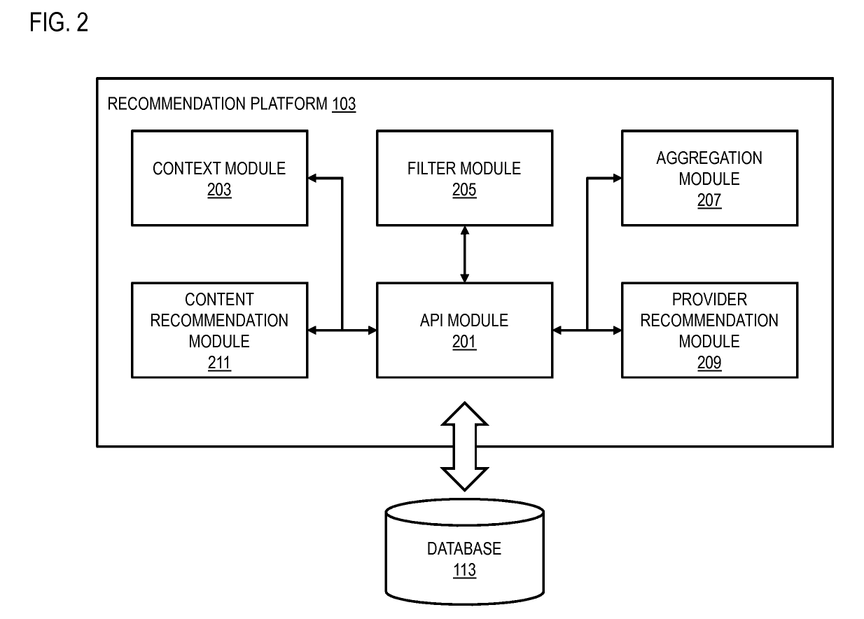

FIG. 2 is a diagram of the components of the recommendation platform 103, according to one embodiment. By way of example, the recommendation platform 103 includes one or more components for providing content providers 115 for recommendation services. It is contemplated that the functions of these components may be combined in one or more components or performed by other components of equivalent functionality. In this embodiment, the recommendation platform 103 includes an application programming interface (API) module 201, a context module 203, a filter module 205, an aggregation module 207, a provider recommendation module 209 and a content recommendation module 211.

The API module 201 interacts with the recommendation application 111 running on the UE 101 for providing content providers 115 for recommendation services and providing the content of the recommendation services. In one embodiment, the API module 201 receives and transmits the incoming and outgoing data, respectively, to the outside of the recommendation platform 103 (for example, to the recommendation application 111, the service platform 109 or the content providers 115). In one embodiment, the API module 201 also interacts with the recommendation application 111 to provide the user interface (UI) to the UE 101 and the user. In one embodiment, the API module 201 also acts as the control module for the other modules of the recommendation platform 103.

The recommendation platform 103 also contains the context module 203. In one embodiment, the context module 203 has three functions.

In one function, the context module 203 determines the context information of the UE 101, the user of the UE 101, or a combination thereof upon receiving a request from the UE 101 to use the recommendation platform 103. In one embodiment, the context information comprises the particular situational aspects of the UE 101 and/or the client of the UE 101. The context module 203 can automatically determine the context information of the UE 101 and/or the user of the UE 101 based on, for example, applications running on the UE 101 (e.g., navigation, calendar, contacts lists, etc.), triangulation techniques based on the wireless signals transmitting to and from the UE 101, GPS services associated with the UE 101, date and time, etc. upon receiving the request. Alternatively, the context module 203 can determine the context information from information being embedded in the request that the UE 101 determines based on the above examples used by the recommendation platform 103. The context module 203 also determines context information of the UE 101 and/or the user of the UE 101 based on information being provided manually from the user. In one embodiment, certain types of context information can be configured to only be sent by the user of the UE 101 and not automatically detected by the recommendation platform 103. In one embodiment, although several different types of context information may be available to the context module 203, the context module 203 may use only a subset of the available information. By way of example, the context information may include the current location of the UE 101 and an intended destination of the user of the UE 101 in the near future detected based on an active navigation route in a navigation application running on the UE 101. The context module 203 can determine that the destination is more relevant than the current location because the user of the UE 101 is most likely looking for recommendations regarding the location of the destination and not the current location.

Non-limiting examples of the context information include, for example, the location of the UE 101 and/or the user of the UE 101, the time, the day of the week, a destination along a navigation route associated with the UE 101 and/or the user of the UE 101, addresses provided in a contacts list stored on the or running as another application of the UE 101, etc.

In one other function, the context module 203 compares the determined context information to contextual relevance information associated with the stored content providers 115 to determine what content providers 115 match the specific context information of the UE 101 and/or the user of the UE 101, discussed in detail below.

In one other function, the context module 203 determines the contextual relevance information in registration or update requests sent to the recommendation platform 103 by the various content providers 115. Upon determining the contextual relevance information, the context module 203 stores the contextual relevance information in the database 113 associated with the specific content provider 115, discussed in detail below.

The recommendation platform 103 also contains the filter module 205. In one embodiment, the filter module 205 has two functions. In one function, the filter module 205 processes content by applying semantic filters to the content to further narrow down the content providers 115 to one or more content providers 115 that provide the specific content. In one embodiment, content-type names present in the request are used to narrow the available content providers 115 presented to the user for the recommendation services. The content-type names can be general, such as audio, video or pictures, or they can be specific relating to a specific piece of audio or video. In one embodiment, noun tags present in the content of the request that denote content type are to narrow the available content providers 115 presented to the user for recommendation services. In one embodiment, a user selects a certain recommendation channel, such as food recommendation, and the filter module 205 filters the available content providers 115 based on the semantic filter of food as a first step. In one embodiment, the user highlights a content provider 115 that provides content regarding food tentatively selects the provider. In response, the filter module 205 filters the available content providers 115 based on the semantic filter information associated with the specific content provider 115.

In the other function, the filter module 205 determines the semantic relevance descriptions in the registration or update requests sent to the recommendation platform 103 by the various content providers 115 when registering or updating their information with the recommendation platform 103. Upon determining the semantic relevance descriptions, the filter module 205 stores the semantic relevance descriptions in the database 113 associated with the specific content provider 115, discussed in detail below.

The aggregation module 207 determines possible recommendations that are related to the recommendation request of the user. If the aggregation module 207 determines that other recommendations exist that are related to the recommendation request of the user, the aggregation module 207 will aggregate additional content providers 115 that contain the content required to make the additional recommendations with the content providers 115 determined by the context module 203 and the filter module 205. By providing the additional content providers 115 that provide content for additional recommendations with the content providers 115 selected to make the original recommendations, the aggregation module 207 can provide complementary content to the user that may not have been explicitly requested but is still valuable. In one embodiment, the aggregation module 207 always determines possible recommendations that are related to the specified recommendation by the user. In one embodiment, the user is able to specify whether to use the aggregation module 207 or receive recommendations with aggregation of additional content providers 115 and recommendations.

The provider recommendation module 209 recommends one or more content providers 115 to provide content for the recommendation services rather than have the user of the UE 101 choose one or more content providers 115. In one embodiment, the user of the UE 101 can choose whether the recommendation platform 103 recommends content providers 115. If chosen to recommend one or more content providers 115, the provider recommendation module 209 determines the recommended content providers 115 based on, for example, user past behavior regarding selecting content providers 115, configuration information, content information regarding the request, or a combination thereof. The recommendation (selection of one more content providers) can also be based on collaborative filtering or any other recommendation technology.

The content recommendation module 211 takes the content from the selected or recommended one or more content providers 115 and recommends content. The context information, the content of the request as well as the user information, such as past behavior and configuration information are used according to various advanced recommendation technologies. The recommendations can be based on collaborative filtering or any other recommendation technology.

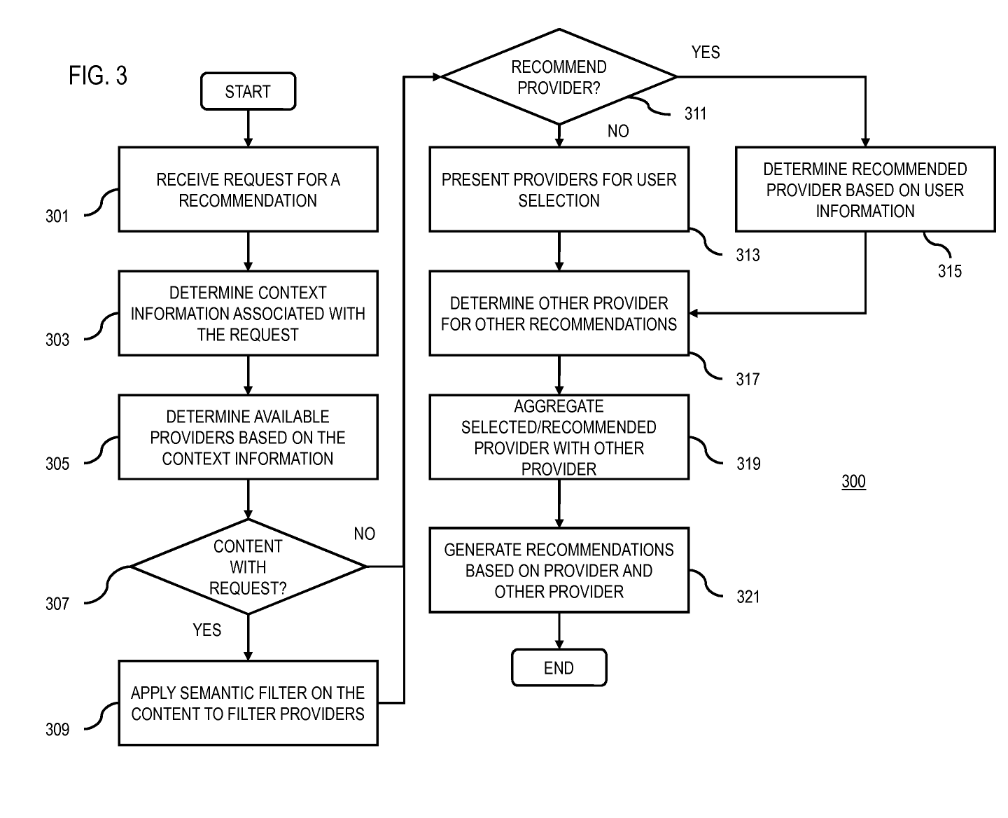

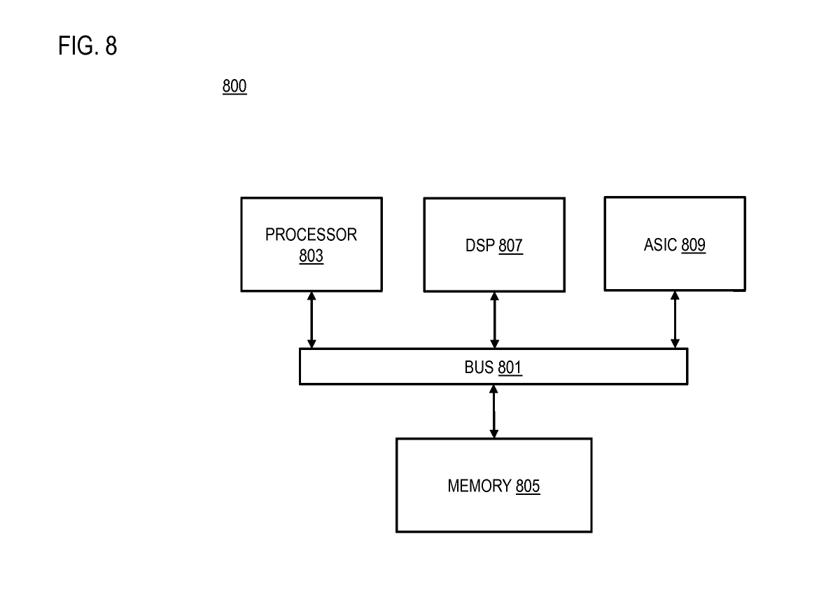

FIG. 3 is a flowchart of a process 300 for providing content providers 115 for recommendation services, according to one embodiment. In one embodiment, the recommendation platform 103 performs the process 300 and is implemented in, for instance, a chip set including a processor and a memory as shown in FIG. 8.

In step 301, the user of the UE 101 sends a request for the recommendation of content to the recommendation platform 103 through the API module 201 from a UE 101. In one embodiment, the request is a GET data providers request without content. In one embodiment, the request is a GET data providers request with content. With both requests, context information of the UE 101 and/or the user of the UE 101 is either sent with the request or the recommendation platform 103 thereafter automatically collects the context information.

In step 303, in respect to the request in step 301 (e.g., the GET data providers request), the recommendation platform 103 determines the context information associated with the request. As discussed above, the context information can be any type information regarding the context of the UE 101 and/or the user of the UE 101. By way of example, in one embodiment the context information is the geographical location of the UE 101 (e.g., Chicago, Ill., USA). This context information is either sent with the GET data providers request or is automatically collected by the recommendation platform 103 after receiving the request.

In step 305, the recommendation platform 103 processes the context information to determine one or more providers that can provide content related to the context information for the recommendation services. The recommendation platform 103 using the context module 203 determines whether the context information matches, at least in part, contextual relevance information stored in the database 113 and associated with the content providers 115 registered with the recommendation platform 103. By way of example, the context module 203 uses various matching algorithms to determine whether a content provider 115 associated with certain contextual relevance information sufficiently matches the context information of the UE 101 and/or the user of the UE 101 to determine that the content provider 115 is available to provide content for the recommendation services. In one embodiment, any match of the context information determines that the content provider 115 associated with the contextual relevance information is available for the recommendation services. In one embodiment, a complete match of the context information with the contextual relevance information determines that the content provider 115 associated with the contextual relevance information is available for the recommendation services.

In step 307, the recommendation platform 103 determines whether there is content associated with the request. In the case where there is no content in the request, such as when the user of the UE 101 wants to be presented with a list of all available content providers 115 based on the context information, the process 300 proceeds to step 311. In the case where there is content in the request, such as when the user specifies a specific type of content, the user selects a certain recommendation channel, or highlights a certain content provider 115, the process 300 proceeds to step 309.

In step 309, the recommendation platform 103 processes content associated with the request to determine one or more providers that provide content through recommendation services that match the requested content. The recommendation platform 103 applies semantic filters on the content to filter out the content providers 115 that do not have matching semantic relevance information. By way of example, the content of the requests includes a noun tag such as “picture.” Any content provider 115 that does not include content in the form of pictures is filtered out of the available content providers 115 presented to the user. A further example is a noun tag such as “Italian.” Any content provider 115 that does not include content associated with the noun tag “Italian” is filtered out of the available content providers 115 presented to the user.

In step 311, the recommendation platform 103 determines whether the user of the UE 101 requested for the recommendation platform 103 to recommend one or more content providers 115. If the user of the UE 101 did request that the recommendation platform 103 recommend one or more content providers 115, the process 300 proceeds to step 315. Otherwise, the process 300 proceeds to step 313.

In step 313, the recommendation platform 103 presents a list of one or more content providers 115 that matched the context information of the UE 101 and/or the user of the UE 101, narrowed down by step 309 if the request contained content, to the user for selection of one or more content providers 115 that will provide content for the recommendation services.

In step 315, the recommendation platform 103 recommends one or more of the content providers 115 that matched the context information of the UE 101 and/or the user of the UE 101, narrowed down by step 309 if the request contained content, to the user for selection. The recommendation is based on, for example, user information, such as past behavior and preferences, along with configuration information and any semantic filter information contained in the request. The recommendation can also be based on collaborative filtering or any other recommendation technology.

In step 317, the recommendation platform 103 determines one or more other content providers 115 for providing recommendation content that is associated with the recommendation content requested by the user. By determining other content providers 115 with additional recommendation content, the recommendation platform 103 can provide useful additional recommendation services to the user without the user requesting the additional recommendation services. By way of example, the user requests recommendation services related to recommending an Italian restaurant for dinner. The recommendation platform 103, through the aggregation module 207, determines that content providers 115 that provide content related to parking information are associated with the content providers 115 that provide content regarding restaurant information based on heuristics stored in the database 113. Thus, when providing recommendations services regarding Italian restaurants, the recommendation platform 103 also provides recommendation services regarding parking

In one embodiment, the determination is based on pre-defined heuristics of the content providers 115 that are independent of the content providers 115 and determined by the service provider of the recommendation platform 103. In one embodiment, the heuristics can be generated by the content providers 115 based on overlapping semantic relevance descriptions provided by the content providers 115 when registering with the recommendation platform 103. In one embodiment, the determination of content providers 115 can be determined based on content of the request overlapping different types of content providers 115. By way of example, one request contains the request “breakfast and rental car.” Based on the overlapping noun tags of “breakfast” and “rental car,” the recommendation platform can determine to provide both content providers 115 that concern “breakfast,” such as restaurants, and content providers 115 that concern “rental cars,” such as local rental car agencies. Thus, despite the recommendation platform not pre-defining “breakfast” with “rental cars,” the recommendation platform can determine a link between the content providers 115.

In step 319, the recommendation platform 103 aggregates the one or more content providers 115 determined by the recommendation platform 103 or selected by the user with the one or more content providers 115 associated with the selected content provider 115 to provide recommendation services based on the content from both content providers 115. However, in one or more embodiments, the user of the UE 101 determines to skip steps 317 and 319, or steps 317 and 319 are entirely not present.

In step 321, the recommendation platform 103 generates recommendations based on the content provided by the one or more selected content providers 115, and associated content providers 115 determined, if any, in step 317 in response to a GET content request. The recommendations are based on one or more recommendation technologies associated with selected and associated content providers 115 and recommend content provider 115 by the one or more content providers 115.

One or more of the steps listed in process 300 can be transparent to the user of the UE 101. By way of example, the user of the UE 101 inputs a request at the recommendation platform 103 for recommendation services regarding a local attraction to visit in Finland. Depending on the number of available content providers 115 that provide content that match the request, and whether the user selected to have the recommendation platform 103 recommend a content provider 115, steps 301 through 321 are transparent to the user and the user simply receives at the UE 101 the desired recommendations. Thus, the user can efficiently and effectively navigate through a multitude of different content providers 115 and receive the desired recommendation services.

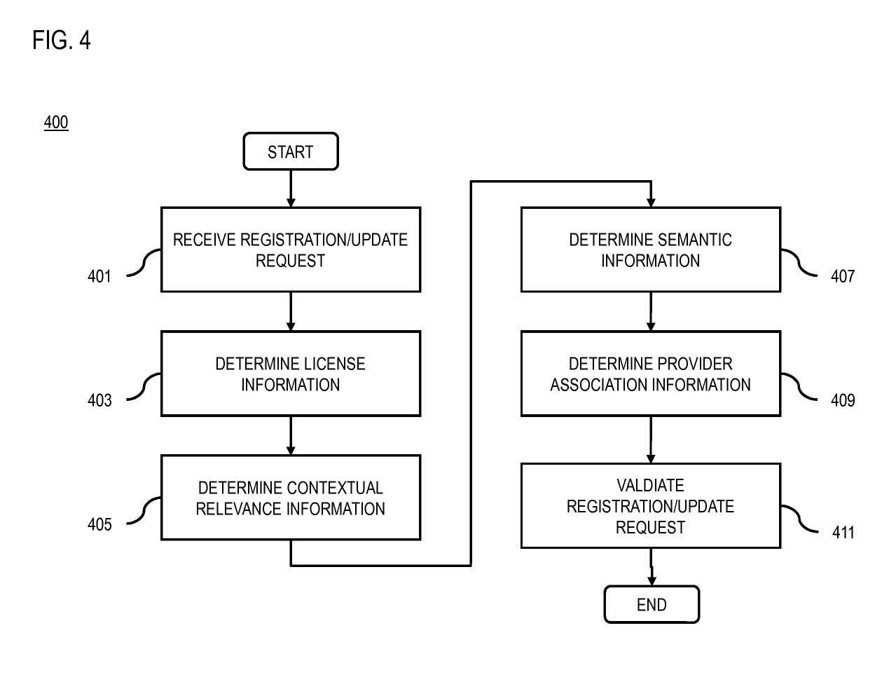

FIG. 4 is a flowchart of a process 400 for registering and/or updating content providers 115 for recommendation services, according to one embodiment. In one embodiment, the recommendation platform 103 performs the process 400 and is implemented in, for instance, a chip set including a processor and a memory as shown in FIG. 8.

In step 401, the recommendation platform 401 receives a request from a content provider 115 to register or update pre-existing information regarding the content provider 115 on the recommendation platform 103. In one embodiment, the content provider 115 will enter into a contract with the service provider providing the services of the recommendation platform 103. When registering for the first time, each content provider 115 will provide contextual relevance information and semantic descriptions of the provided content. The content provider 115 will also provide license information. Updates to pre-existing content provider 115 information can include only new information or new information in addition to the information previously submitted to the recommendation platform 103 by the content provider 115. The request can be formatted in any machine readable language, such as extensible markup language (XML), hypertext markup language (HTML), etc.

In step 403, the recommendation platform 103 determines the license information within the request from the content provider 115. The recommendation platform 103 stores the license information in the database 113 associated with the specific content provider 115.

In step 405, the recommendation platform 103 determines the contextual relevance information within the request from the content provider 115. In one embodiment, each registration or update request will have a set of context description packages that provide the content provided by the content provider 115 under a specific context. By way of example, the location is used as the context information and the content provided indicates in the request that the provided content is for the specific location, such as a country or region. The context relevance information provided in the request can be provided in many different ways, such as a name of a country, latitude and longitude coordinates for the center of the location along with a range around the center, latitude and longitude lines for the boundary of the location, etc. The recommendation platform can also communicate with one or more services 107 running on the service platform 109 to translate between different formats of the contextual relevance information. For example, if the contextual relevance information provided in the request is a name of a country, the recommendation platform 103 can obtain from a service 107 the latitude and longitudes of the boundary of the country or a center point of the country and the average distance between the center point and the border of the country. Translation between different formats of contextual relevance information allows the system to accept many different types of inputs from a content provider 115.

In step 407, the recommendation platform 103 determines semantic relevance descriptions of the content provided by the content provider 115 associated with the request. In one embodiment, the semantic relevance description is descriptive tags, such as restaurant, eatery, food, Italian, Indian, French, etc. for a content provider 115 that provides information regarding restaurants. However, the description tags can cover a multitude of different descriptions as general as audio, video, pictures, for content providers 115 that provide content of audio, video, pictures, to narrowly tailored descriptive tags. In one embodiment, the semantic relevance description is a link to standard tag definitions such as www.wikipedia.com/restaurantTags. In one embodiment, the semantic relevance description is the name of the content with additional constraints provided through a schema definition. One request can have one or more of the different types of semantic relevance descriptions. The semantic relevance information can also define the source of the content provider 115, such as a paid versus free content provider 115, a blog content provider 115, an open source content provider 115, etc.

In step 409, the recommendation platform 103 determines content provider 115 association information between the content provider 115 making the registration or update request and content providers 115 already registered with the recommendation platform 103. In one embodiment, the recommendation platform 103 determines association information according to pre-defined heuristics. By way of example, if the content provider 115 requesting registration provides content regarding parking information, a set rule in the heuristics matches the content provider 115 with content providers 115 that provide restaurant information in the same location. Thus, the recommendation platform 103 can provide parking recommendation services with the restaurant recommendation services in the same area. In one embodiment, the recommendation platform 103 determines association information based on similarities between the semantic relevance descriptions of the new or updated content provider 115 and already registered content providers 115. For example, overlapping semantic relevance descriptions between content providers 115 indicates that they, although not directly related, may be indirectly related such that the content they provide would be beneficially presented to the user of the recommendation platform 103 in a mash-up manner. In one embodiment, the recommendation platform 103 uses both pre-defined heuristics and dynamic links between content providers 115 as the content providers 115 register with the recommendation platform.

In step 411, the recommendation platform 103 validates the registration or update request. The validation is performed, for example, based on the contextual relevance information, the semantic description information and the license information provided in the request. In one embodiment, the license information will include the type of content that the content provider 115 is providing. The recommendation platform 103 crosschecks the type of content listed in the license information with the type of information listed in the semantic description information to validate the request. In one embodiment, the license information will include limitations regarding the license that can be translated into contextual relevance information and crosschecks with the contextual relevance information to validate the request. By way of example, the license information will include a geographical area over which the content provider 115 is authorized to provide content. The recommendation platform 103 crosschecks the geographical area provided in the license information with the geographical area provided in the contextual relevance information to validate the request. In the event that any information is missing in the request or is incomplete, the recommendation platform 103 can notify the requesting content provider 115 of any issues with the request and/or update missing or incomplete information of the request to generate a more complete request. By way of example, if the request does not contain contextual relevance information regarding a geographic area over which the content provider 115 can provide content, but the license includes a geographic area over which the content provider 115 is licensed to provide content, the recommendation platform 103 can update the contextual relevance information associated with the request to include the geographic information with the license information.

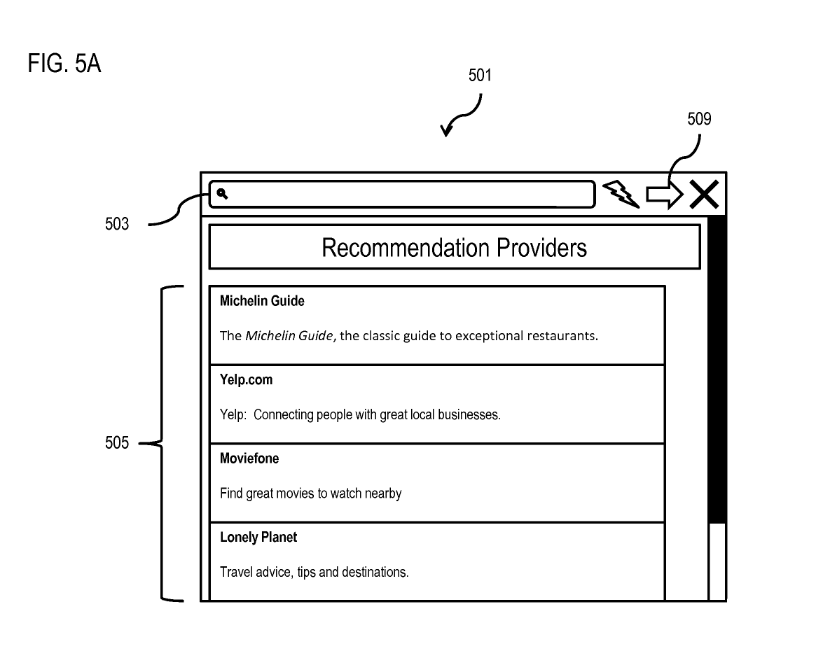

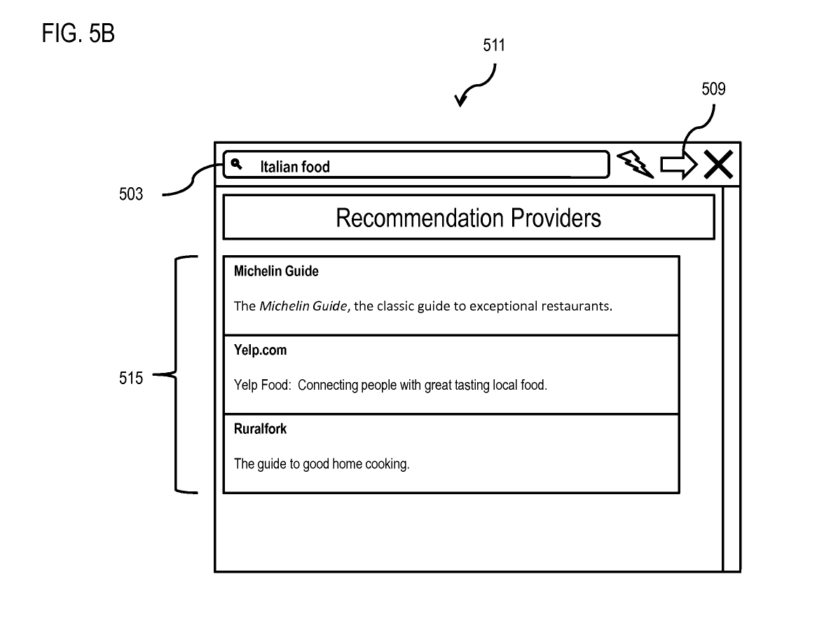

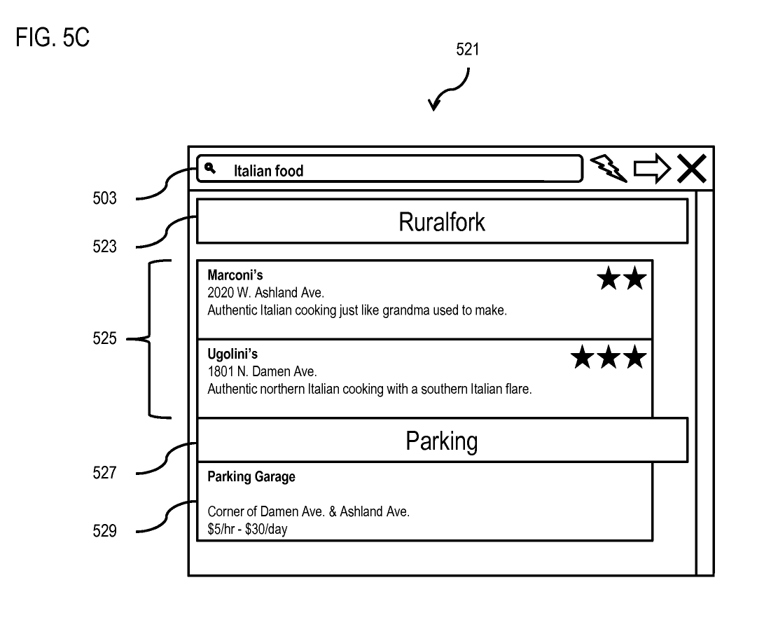

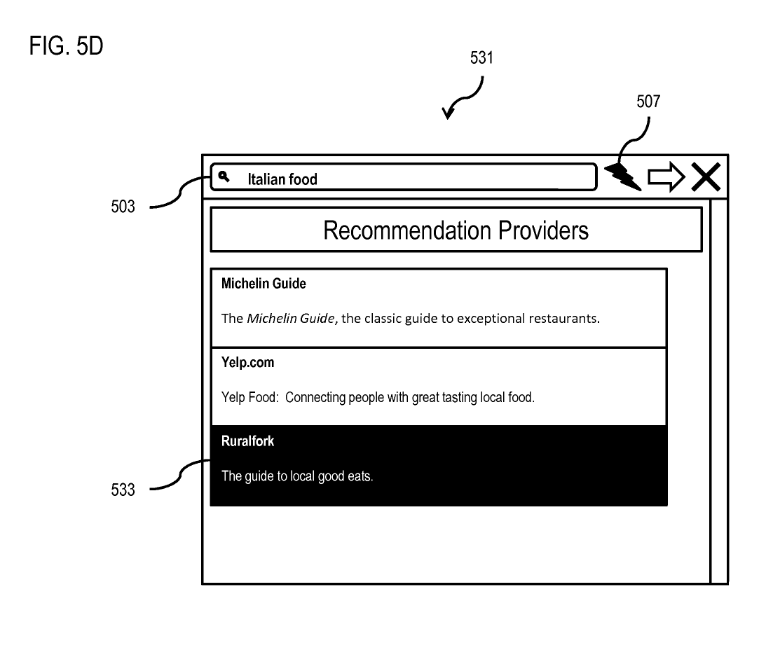

FIGS. 5A-5D are diagrams of user interfaces utilized in the processes of FIG. 3, according to various embodiments. In FIG. 5A, indicator 501 illustrates the user interface of the UE 101 after a user selects the query indicator 509 without any content in the query box 503. By selecting the query indicator 509 without containing content in the query box 503, the recommendation platform 103 determines the available content providers 115 based solely on the context information of the UE 101 and/or the user of the UE 101. By way of example, the user selecting the query indicator 509 without information in the query box 503 amounts to sending a GET data providers request without content. Indicator 505 illustrates a list of content providers 115 that are available to provide content for the recommendation services based on the context information of the UE 101 and/or the user of the UE 101.

In FIG. 5B, indicator 511 illustrates the user interface of the UE 101 after a user selects the query indicator 509 with the content of “Italian food” in the query box 503. In response, the recommendation platform 103 determines the available content providers 115 based on the context information of the UE 101 and/or the user of the UE 101, and further narrows down the available content providers 115 to those that provide content regarding Italian food based on applying a semantic filter on the content. Thus, indicator 515 illustrates a list of content providers 115 that are available and provide content for recommendation services based on the context information of the UE 101 and/or the user of the UE 101 and the content of the request (e.g., Italian food).

In FIG. 5C, indicator 521 illustrates the user interface of the UE 101 after a user selects one of the content providers 115 from the indicator 515 from FIG. 5B. For example, the user selected the content provider 115 “Ruralfork,” as illustrated by indicator 523 in FIG. 5C. The recommendation platform 103 then determines content to present to the user from the content provider 115 “Ruralfork” for recommendation on where to eat Italian food based on the recommendation technologies discussed above. As illustrated by indicator 525, Marconi's and Ugolini's are provided as Italian restaurants based on the content provider 115 Ruralfork. Also provided is indicator 527 illustrating that the recommendation platform 103 determined parking recommendation services should be included in the restaurant recommendation services so that the user knows where to park when attending any one of the restaurants listed in indicator 525. Indicator 529 illustrates a parking recommendation automatically generated by the recommendation platform 103 from a content provider 115 that provides parking information.

In FIG. 5D, indicator 531 illustrates the user interface of the UE 101 providing a recommended content provider 115 based on the user entering “Italian food” in the query box 503. By way of example, the user activates indicator 507 to request for the recommendation platform 103 generate recommendations regarding what content providers 115 should be used to provide content for the recommendation services. As illustrated in FIG. 5D, indicator 533 illustrates the recommended content provider 115 for providing recommendation services based on the query of “Italian food.” In one embodiment, indicator 531 illustrating the recommended content provider 115 is not shown to the user. Instead, the recommendation platform 103 simply proceeds to the next step of process 300 using the recommended content provider 115.

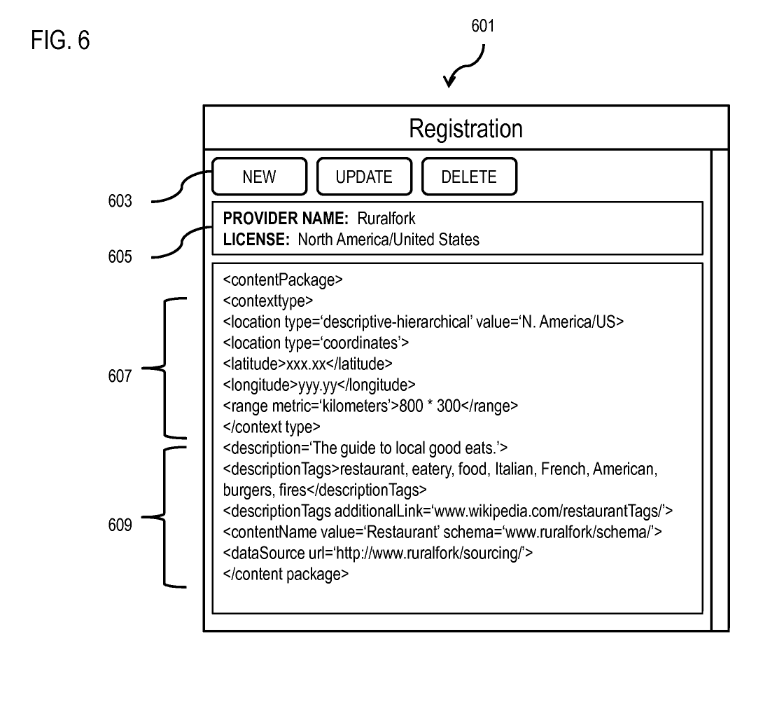

FIG. 6 is a diagram of a user interface utilized in the process of FIG. 4, according to one embodiment. In FIG. 6, indicator 601 illustrates a registration or update of the information associated with a content provider 115. As illustrated in FIG. 6, indicator 603 provides the ability to add new content provider 115 packages in the recommendation platform 103, update content provider 115 packages in the recommendation platform 103, or delete content provider 115 packages in the recommendation platform 103. For a specific content provider 115 package, indicator 605 illustrates the name of the content provider 115 and the license information associated with the content provider 115. As discussed above, the license information of the illustrated content provider 115 in FIG. 6 includes geographic information that can be compared to the contextual relevance information provided in the package to validate the content provider 115 package. Indicator 607 illustrates the contextual relevance information associated with the content package according to the various formats discussed above that is processed by the recommendation platform 103 and stored in the database 113. By way of example, indicator 607 defines the region covered by the content provider 115 based on the name of the geographic region and a range of the geographic region around a center point. Indicator 609 illustrates the semantic relevance description associated with the content package according to the various formats discussed above that is processed by the recommendation platform 103 and stored in the database 113.

The processes described herein for providing content providers for recommendation services may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

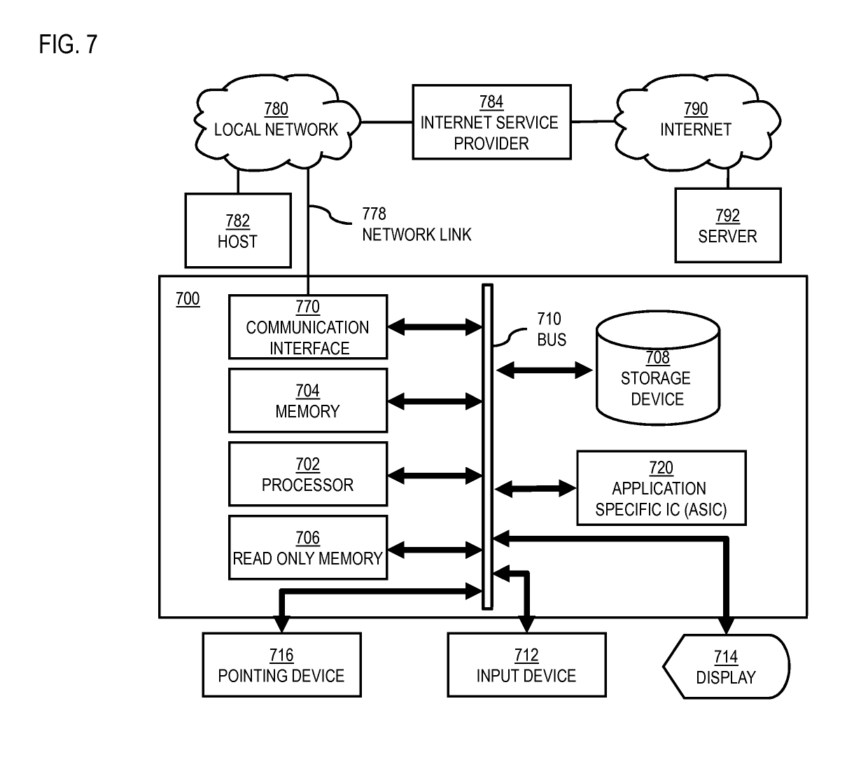

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to provide content providers for recommendation services as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of providing content providers for recommendation services.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to provide content providers for recommendation services. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for providing content providers for recommendation services. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for providing content providers for recommendation services, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for providing content providers for recommendation services to the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to provide content providers for recommendation services as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of providing content providers for recommendation services.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to provide content providers for recommendation services. The memory 805 also stores the data associated with or generated by the execution of the inventive steps.

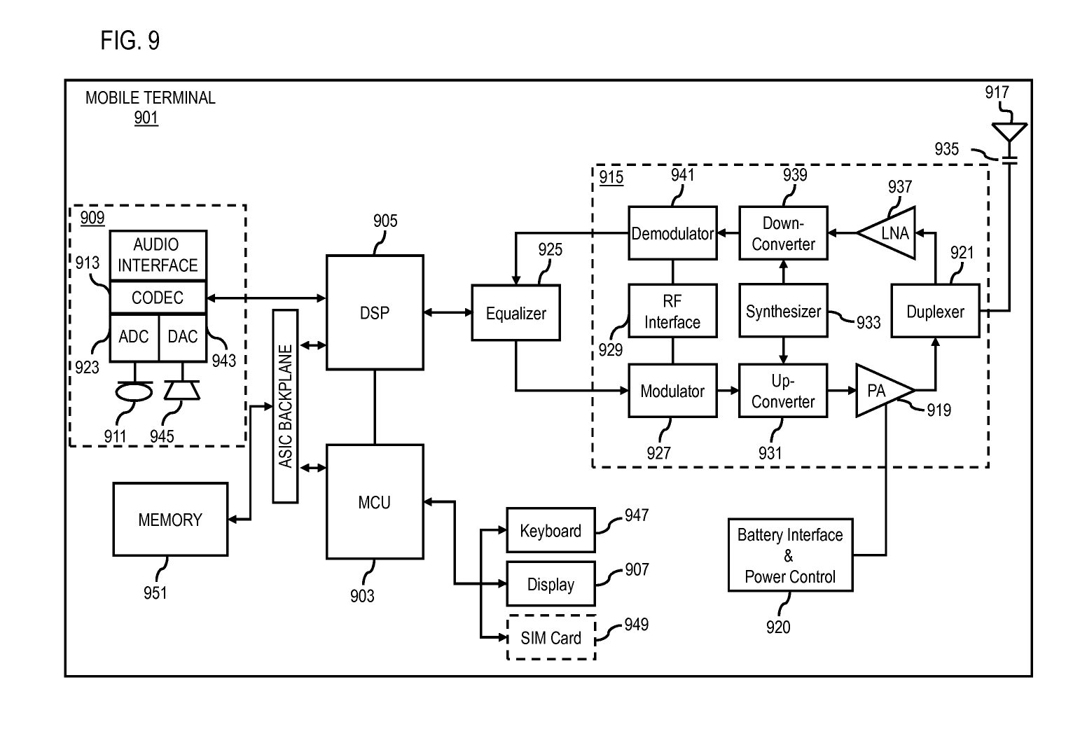

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of providing content providers for recommendation services. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of providing content providers for recommendation services. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to providing content providers for recommendation services. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
at least one request for at least one recommendation from at least one device;
at least one determination of context information associated with the at least one device, a user of the at least one device, or a combination thereof; and
a processing of the context information to determine, at least in part, one or more providers for generating the at least one recommendation.

2. A method of claim 1, wherein the processing of the context information comprises, at least in part, determining that the context information matches contextual relevance information associated with the one or more providers.

3. A method of claim 1, wherein the (1) data and/or (2) information and/or (3) at least one signal are further based, at least in part, on the following:
a processing of content associated with the at least one request, the at least one recommendation, the one or more providers, or a combination thereof to determine, at least in part, the one or more providers.

4. A method of claim 3, wherein the processing of the content comprises causing, at least in part, an application of at least one semantic filter on the content to determine the one or more providers.

5. A method of claim 1, wherein the (1) data and/or (2) information and/or (3) at least one signal are further based, at least in part, on the following:
a processing of user information to recommend at least one provider of the one or more providers.

6. A method of claim 5, wherein the (1) data and/or (2) information and/or (3) at least one signal are further based, at least in part, on the following:
a selecting of the at least one recommended provider based, at least in part, on the user information, configuration information, or a combination thereof; and
a generating of the at least one recommendation by the at least one provider.

7. A method of claim 1, wherein the (1) data and/or (2) information and/or (3) at least one signal are further based, at least in part, on the following:
a processing of the at least one recommendation to determine at least one other recommendation; and
at least one determination of one or more other providers for generating the at least one other recommendation.

8. A method of claim 7, wherein the (1) data and/or (2) information and/or (3) at least one signal are further based, at least in part, on the following:
an aggregation of the at least one recommendation and the at least one other recommendation.

9. A method of claim 1, wherein the (1) data and/or (2) information and/or (3) at least one signal are further based, at least in part, on the following:
a presenting of the one or more providers for selection by the at least one device, the user of the at least one device, or a combination thereof; and
a generating of the at least one recommendation by a selected provider.

10. A method of claim 9, wherein the at least one recommendation is based on, at least in part, one or more recommendation technologies associated with the one or more providers.

11. An apparatus comprising:
at least one processor; and
at least one memory including computer program code for one or more programs,
the at least one memory and the computer program code configured to, with the at least one processor, cause the apparatus to perform at least the following,
receive at least one request for at least one recommendation from at least one device;
determine context information associated with the at least one device, a user of the at least one device, or a combination thereof; and
process and/or facilitate a processing of the context information to determine, at least in part, one or more providers for generating the at least one recommendation.

12. An apparatus of claim 11, wherein the processing of the context information comprises, at least in part, determining that the context information matches contextual relevance information associated with the one or more providers.

13. An apparatus of claim 11, wherein the apparatus is further caused to:
process and/or facilitate a processing of content associated with the at least one request, the at least one recommendation, the one or more providers, or a combination thereof to determine, at least in part, the one or more providers.

14. An apparatus of claim 13, wherein the processing of the content comprises causing, at least in part, an application of at least one semantic filter on the content to determine the one or more providers.

15. An apparatus of claim 11, wherein the apparatus is further caused to:
process and/or facilitate a processing of user information to recommend at least one provider of the one or more providers.

16. An apparatus of claim 15, wherein the apparatus is further caused to:
cause, at least in part, selecting of the at least one recommended provider based, at least in part, on the user information, configuration information, or a combination thereof; and
cause, at least in part, generating of the at least one recommendation by the at least one provider.

17. An apparatus of claim 11, wherein the apparatus is further caused to:
process and/or facilitate a processing of the at least one recommendation to determine at least one other recommendation; and
determine one or more other providers for generating the at least one other recommendation.

18. An apparatus of claim 17, wherein the apparatus is further caused to:
cause, at least in part, an aggregation of the at least one recommendation and the at least one other recommendation.

19. An apparatus of claim 11, wherein the apparatus is further caused to:
cause, at least in part, presenting of the one or more providers for selection by the at least one device, the user of the at least one device, or a combination thereof; and
cause, at least in part, generating of the at least one recommendation by a selected provider.

20. An apparatus of claim 19, wherein the at least one recommendation is based on, at least in part, one or more recommendation technologies associated with the one or more providers.

21-48. (canceled)
